(19) United States
(12) Patent Application Publication
(10) Pub. No.: US 2026/0152681 A1
(43) Pub. Date: Jun. 4, 2026

(54) BIOMASS-DERIVED ADHESIVE COMPOSITION FOR AUTOMOTIVE INTERIOR MATERIALS AND MANUFACTURING METHOD OF AUTOMOTIVE INTERIOR MATERIALS USING THE SAME

(71) Applicants: Hyundai Transys Inc., Seosan-si (KR); MUJIN CHEMICAL Co., Ltd., Yangsan-si (KR)

(72) Inventors: Jun Hyung LIM, Hwaseong-si (KR); Hye Ran KANG, Yangsan-si (KR); Seung Keon WOO, Cheonan-si (KR); Hye Rin CHOI, Hwaseong-si (KR); Jun Ho SONG, Hwaseong-si (KR)

(21) Appl. No.: 19/391,653

(22) Filed: Nov. 17, 2025

(30) Foreign Application Priority Data
Dec. 3, 2024 (KR) 10-2024-0177428

(51) Int. Cl. C09J 177/00; C09J 5/06; C09J 11/06; C09J 11/08

(52) U.S. Cl. CPC C09J 177/00; C09J 5/06; C09J 11/06; C09J 11/08; C09J 2301/304; C09J 2301/408

(57) ABSTRACT

An adhesive composition for automotive interior materials and a manufacturing method of the automotive interior materials using the adhesive composition include: a first resin composition including biomass-derived carboxylic acid monomers and ethylenediamine monomers, a second resin composition including biomass-derived carboxylic acid monomers and hexamethylenediamine monomers, and a heat-resistant additive.

### CROSS-REFERENCE TO RELATED APPLICATION

This application claims the priority of Korean Patent Application No. KR 10-2024-0177428 filed on Dec. 3, 2024, in the Korean Intellectual Property Office, the disclosure of which is incorporated herein by reference in its entirety.

### BACKGROUND

### Field

The present disclosure relates to an adhesive composition for automotive interior materials and a manufacturing method of automotive interior materials using the same. More particularly, the present disclosure relates to an adhesive composition for automotive interior materials, the adhesive composition including: a first resin composition including biomass-derived carboxylic acid monomers and ethylenediamine monomers, a second resin composition including biomass-derived carboxylic acid monomers and hexamethylenediamine monomers, and a heat-resistant additive.

### Description of the Related Art

Automotive interior materials comprise various materials, and bonding between the materials plays an important role in increasing durability, safety and quality. In particular, the bonding between the automotive interior materials needs to be able to maintain bonding performance stably even under high temperature and high humidity conditions, and also meet the light-weight and eco-friendly demands of interior materials. Accordingly, the bonding method needs to be designed in consideration of heat resistance, durability, flexibility, etc. The possibility of dismantling after bonding and ease of recycling are also important considerations.

A conventional thermal fusion method has been restrictively applied to specific materials such as slab padding materials. In this method, dismantlement may be performed only by physical methods, and therefore the dismantlement is incomplete. In addition, additional cutting processes are required after bonding, so that process efficiency is reduced and additional operations are required.

A web hot-melt method is also restrictively applied to slab padding materials. In this method, particularly, it is impossible to bond a 25PPI filter foam for ventilation. In addition, due to a low heat-resistance temperature, there is a risk of damaging sensitive materials such as leather when operating at high temperatures. The method enables only Piece to Piece bonding, so that the range of the process is limited, and causes problems such as leather damage caused by the operations at high temperatures.

A PUR method has limited bonding methods, and also enables only Piece to Piece bonding. Also, as dismantlement may be performed only by physical methods, the resulting dismantlement is incomplete. Most of adhesives used in this method are petroleum-based materials, which lack eco-friendly elements.

Accordingly, there is a continuous demand for research and development of adhesive compositions and bonding methods capable of overcoming the limitations of the conventional bonding methods of automotive interior materials and providing higher efficiency and eco-friendliness.

In this regard, Korean Patent Registration No. 10-2223124 discloses an eco-friendly adhesive composition and a manufacturing method of automotive interior materials using the same.

### SUMMARY

The present disclosure has been devised to solve the problems of the prior arts, and an object of the present disclosure is to provide an adhesive composition for automotive interior materials including: a first resin composition including biomass-derived carboxylic acid monomers and ethylenediamine monomers; a second resin composition including biomass-derived carboxylic acid monomers and hexamethylenediamine monomers; and a heat-resistant additive.

Further, another object of the present disclosure is to provide a manufacturing method of automotive interior materials including: preparing an adhesive composition including: a first resin composition including biomass-derived carboxylic acid monomers and ethylenediamine monomers; a second resin composition including biomass-derived carboxylic acid monomers and hexamethylenediamine monomers; and a heat-resistant additive; forming an adhesive layer by uniformly applying the adhesive composition onto one surface of a substrate; and laminating and heating a surface material on the adhesive layer.

As a technical means for achieving the aforementioned technical problem, one aspect of the present disclosure provides an adhesive composition for automotive interior materials, the adhesive composition including: a first resin composition including first carboxylic acid monomers and ethylenediamine monomers; a second resin composition including second carboxylic acid monomers and hexamethylenediamine monomers; and a heat-resistant additive.

A weight mixing ratio of the first resin composition and the second resin composition may be 1:3 to 1:12.

A weight ratio of the first carboxylic acid monomers and ethylenediamine monomers included in the first resin composition may be 100:17 to 100:54.

A weight ratio of the second carboxylic acid monomers and hexamethylenediamine monomers included in the second resin composition may be 100:33 to 100:82.

A melting point of the first resin composition may be 108 to 112° C., and a melting point of the second resin composition may be 70 to 80° C.

The first carboxylic acid monomers or the second carboxylic acid monomers may be selected from the group consisting of stearic acid, sebacic acid, undecanedioic acid, dodecanedioic acid, tridecanedioic acid, tetradecanedioic acid, and a combination thereof.

The heat-resistant additive may be included in an amount of 1 to 3 parts by weight with respect to 100 parts by weight of the first resin composition and the second resin composition.

The heat-resistant additive may include a material selected from the group consisting of a compound having a structure represented by a following Chemical Formula 1, calcium carbonate, bentonite, sorbitol, phosphate salts, calcium carboxylate, and a combination thereof.

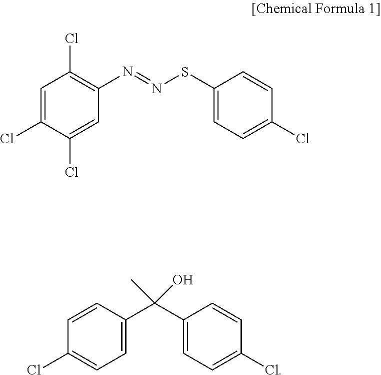 [SMILES: Clc1ccc(S/N=N/c2cc(Cl)c(Cl)cc2Cl)cc1 ; CC(O)(c1ccc(Cl)cc1)c1ccc(Cl)cc1]

The material selected from the group consisting of the compound having the structure of Chemical Formula 1, calcium carbonate, bentonite, sorbitol, phosphate salts, calcium carboxylate, and a combination thereof may be included in an amount of 0.5 to 1 part by weight with respect to 100 parts by weight of the first resin composition and the second resin composition.

The heat-resistant additive may further include a polymer material selected from the group consisting of polyurethane-based polymers, polyester-based polymers, polyamide-based polymers, and a combination thereof.

The polymer material selected from the group consisting of polyurethane-based polymers, polyester-based polymers, polyamide-based polymers, and a combination thereof may be included in an amount of 0.5 to 2.5 parts by weight with respect to 100 parts by weight of the first resin composition and the second resin composition.

The adhesive composition may further include an antioxidant.

The antioxidant may be included in an amount of 1 to 3 parts by weight with respect to 100 parts by weight of the first resin composition and the second resin composition.

The first carboxylic acid monomers, the ethylenediamine monomers, the second carboxylic acid monomers, or the hexamethylenediamine monomers may be biomass-derived. The biomass may include corn, sugarcane, rice straw, castor bean, conifers, starch, resin, lignin, soybean oil, sugar beet, potato, rice husks, bamboo, coconut, sunflower, flax, rice bran, Camelina sativa, seakale, barley stalks, wheat stalks, kenaf, or a combination thereof.

A bonding temperature of the adhesive composition may be 75 to 95° C.

Another aspect of the present disclosure provides an automotive interior material manufactured using the adhesive composition.

Yet another aspect of the present disclosure provides a method of manufacturing automotive interior materials, the method including: preparing an adhesive composition including: a first resin composition including first biomass-derived carboxylic acid monomers and biomass-derived ethylenediamine monomers; a second resin composition including second biomass-derived carboxylic acid monomers and biomass-derived hexamethylenediamine monomers; and a heat-resistant additive; forming an adhesive layer by uniformly applying the adhesive composition onto one surface of a substrate; and laminating and heating a surface material on the adhesive layer.

The forming of the adhesive layer may be forming the adhesive layer by melt-spraying the adhesive composition onto the one surface of the substrate.

The melt-spraying of the adhesive composition may be injecting the adhesive composition through a hole having a diameter of 0.03 to 0.3 mm.

The heating of the surface material may be performed at a temperature of 75 to 95° C.

According to the present disclosure, the adhesive composition and the automotive interior materials using the same use biomass-derived materials, and thus are not only eco-friendly, but also have excellent heat resistance and enable bonding at low temperatures, thereby providing an advantage of preventing shrinkage and damage to leather or surface materials.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view illustrating an automotive interior material according to an example of the present disclosure;

FIGS. 2A and 2B are graphs showing results of measuring the melting points of a first resin composition and a second resin composition used in an adhesive composition for automotive interior materials according to one example of the present disclosure;

FIG. 3 is a photograph observing states of an automotive interior material after performing evaluation of bonding strength, heat cycle resistance, creep durability, and bending wrinkles on the automotive interior material according to one example of the present disclosure;

FIG. 4 is a photograph observing a state of an automotive interior material after performing evaluation of creep durability on the automotive interior material according to one Comparative Example of the present disclosure;

FIG. 5 is a photograph observing a state of an automotive interior material after performing evaluation of creep durability on the automotive interior material according to one Comparative Example of the present disclosure;

FIG. 6 is a photograph observing a state of an automotive interior material after performing evaluation of creep durability on the automotive interior material according to one Comparative Example of the present disclosure;

FIG. 7 is a photograph observing states after performing evaluation of bonding strength, heat cycle resistance, and creep durability on an automotive interior material according to one Comparative Example of the present disclosure, respectively;

FIG. 8 is a photograph observing states after performing evaluation of heat cycle resistance and creep durability on an automotive interior material according to one Comparative Example of the present disclosure, respectively;

FIG. 9 is a photograph showing a side (upper part) and a surface (lower part) of an automotive interior material, after performing evaluation of bending wrinkles on the automotive interior material according to one Comparative Example of the present disclosure; and

FIG. 10 is a photograph observing states after performing evaluation of bonding strength, heat cycle resistance, creep durability, and bending wrinkles on an automotive interior material according to one Comparative Example of the present disclosure, respectively.

### DETAILED DESCRIPTION

Hereinafter, the present disclosure will be described in more detail. However, the present disclosure may be embodied in various different forms, and the present disclosure is not limited by examples described herein, and the present disclosure will be only defined by claims to be described below.

Furthermore, terms used in the present disclosure are used only to describe specific examples, and are not intended to limit the present disclosure. A singular expression includes a plural expression unless the context clearly indicates otherwise. Throughout the present specification, unless explicitly described to the contrary, ‘comprising’ a certain component means further comprising the other component other than excluding the other component.

A first aspect of the present disclosure provides an adhesive composition for automotive interior materials, the adhesive composition including: a first resin composition including biomass-derived carboxylic acid monomers and ethylenediamine monomers, a second resin composition including biomass-derived carboxylic acid monomers and hexamethylenediamine monomers, and a heat-resistant additive.

Hereinafter, the adhesive composition for automotive interior materials according to the first aspect of the present disclosure will be described in detail.

In one embodiment of the present disclosure, the adhesive composition for automotive interior materials includes biomass-derived monomers, and more particularly, the adhesive composition for automotive interior materials includes at least 70% of biomass-derived materials, which is very eco-friendly.

The “biomass” refers to biological organisms such as plants, microorganisms, fungi, and animals that receive solar energy. Biomass raw materials include, for example, plant-derived environmentally circulating resources, such as starch-based resources such as grains and potatoes, cellulose-based resources such as herbs, timber, rice straw, and rice husks, and carbohydrate-based resources such as sugarcane and sugar beet; animal-derived environmentally circulating resources such as livestock manure, carcasses, and microbial cells; and various organic wastes such as paper and food waste derived from these resources.

In the present disclosure, the expression such as the “biomass-derived” carboxylic acid monomer, ethylenediamine monomer or hexamethylenediamine monomer is used to mean carboxylic acid monomers, ethylenediamine monomers or hexamethylenediamine monomers obtained by physically, chemically and/or biologically treating these biomass raw materials.

In one embodiment of the present disclosure, the adhesive composition for automotive interior materials includes: a first resin composition including biomass-derived carboxylic acid monomers and ethylenediamine monomers, and a second resin composition including biomass-derived carboxylic acid monomers and hexamethylenediamine monomers. The weight mixing ratio of the first resin composition and the second resin composition may be 1:3 to 1:12, preferably, the weight mixing ratio of the first resin composition and the second resin composition may be 1:5 to 1:11, and more preferably, the weight mixing ratio of the first resin composition and the second resin composition may be 1:7 to 1:10. At this time, when the weight mixing ratio of the first resin composition and the second resin composition is less than 1:3, the content of the second resin composition is insufficient, so that the melting point is higher than the bonding temperature of the adhesive composition, which may cause a problem in which bonding is impossible, and the bonding strength, heat cycle resistance, and creep durability may be reduced. In addition, when the weight mixing ratio of the first resin composition and the second resin composition is more than 1:12, the content of the second resin composition having a relatively low melting point is larger than that of the first resin composition. As such, the melting point of the manufactured adhesive composition may be lowered, and as a result, a problem may occur in that a desired level may not be achieved in the creep durability evaluation, in which the adhesive composition is required to withstand a temperature of 80° C. for 24 hours.

In one embodiment of the present disclosure, the weight ratio of the carboxylic acid monomers and the ethylenediamine monomers included in the first resin composition may be 100:17 to 100:54. At this time, when the weight ratio of the carboxylic acid monomers and the ethylenediamine monomers is less than 100:17, the amount of the ethylenediamine monomers, which play an important role in the strength and durability of the adhesive, is not sufficient, and thus a problem may occur in that the adhesive layer becomes weak to be easily be damaged by external impact or vibration. When the weight ratio of the carboxylic acid monomers and the ethylenediamine monomers is more than 100:54, the amount of the carboxylic acid monomers, which play a role in strengthening the adhesiveness and chemical bonding strength of the adhesive, is not sufficient, and thus there may be a problem of reduced bonding strength.

In one embodiment of the present disclosure, the weight ratio of the carboxylic acid monomers and the hexamethylenediamine monomers included in the second resin composition may be 100:33 to 100:82. At this time, when the weight ratio of the carboxylic acid monomers and the hexamethylenediamine monomers is less than 100:33, the content of the hexamethylenediamine monomers, which contribute to the physical strength and durability of the adhesive, is insufficient, which may increase the possibility of decreasing long-term durability. When the weight ratio of the carboxylic acid monomers and the hexamethylenediamine monomers is more than 100:82, the content of the carboxylic acid monomers may be relatively insufficient, which may cause problems such as reduced bonding strength, reduced heat resistance, and reduced moisture resistance.

In one embodiment of the present disclosure, the molar ratio of the carboxylic acid monomers and the ethylenediamine monomers included in the first resin composition may be 1:0.7 to 1:1.3, preferably 1:0.8 to 1:1.2, and more preferably 1:0.9 to 1:1.1. At this time, when the molar ratio of the carboxylic acid monomers and the ethylenediamine monomers included in the first resin composition is less than 1:0.7 or more than 1:1.3, amide bonds or cross-linking bonds between the carboxylic acid monomers and the ethylenediamine monomers may be formed incompletely. Accordingly, problems of reduced mechanical strength or reduced durability of automotive interior materials manufactured using the adhesive composition may occur.

In one embodiment of the present disclosure, the molar ratio of the carboxylic acid monomers and the hexamethylenediamine monomers included in the second resin composition may be 1:0.7 to 1:1.3, preferably 1:0.8 to 1:1.2, and more preferably 1:0.9 to 1:1.1. At this time, when the molar ratio of the carboxylic acid monomers and the hexamethylenediamine monomers included in the second resin composition is less than 1:0.7 or more than 1:1.3, the cross-linking bonds between the carboxylic acid monomers and the hexamethylenediamine monomers may be formed incompletely. Accordingly, problems of reduced thermal stability or reduced moisture resistance of automotive interior materials manufactured using the adhesive composition may occur.

In one embodiment of the present disclosure, the melting point of the first resin composition may be 108 to 112° C., and the melting point of the second resin composition may be 70 to 80° C.

In one embodiment of the present disclosure, the carboxylic acid monomer may be selected from the group comprising stearic acid, sebacic acid, undecanedioic acid, dodecanedioic acid, tridecanedioic acid, tetradecanedioic acid, and combinations thereof.

In one embodiment of the present disclosure, the content of the heat-resistant additive may be included in an amount of 1 to 3 parts by weight with respect to 100 parts by weight of the first resin composition and the second resin composition. At this time, when the content of the heat-resistant additive is less than 1 part by weight with respect to 100 parts by weight of the first resin composition and the second resin composition, problems of reduced heat cycle resistance or reduced creep durability may occur. When the content of the heat-resistant additive is more than 3 parts by weight with respect to 100 parts by weight of the first resin composition and the second resin composition, the content of the heat-resistant additive is high, which may cause a problem that bending wrinkles occur or bonding strength is reduced.

In one embodiment of the present disclosure, the heat-resistant additive may include a material selected from the group comprising a compound having a structure of the following Chemical Formula 1, calcium carbonate, bentonite, sorbitol, phosphate salts, calcium carboxylate, and combinations thereof. More preferably, the heat-resistant additive may include the compound having the structure of the following Chemical Formula 1.

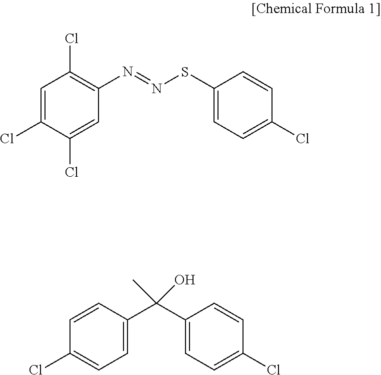 [SMILES: Clc1ccc(S/N=N/c2cc(Cl)c(Cl)cc2Cl)cc1 ; CC(O)(c1ccc(Cl)cc1)c1ccc(Cl)cc1]

In one embodiment of the present disclosure, the content of the material selected from the group comprising the compound having the structure of Chemical Formula 1, calcium carbonate, bentonite, sorbitol, phosphate salts, calcium carboxylate, and combinations thereof may be included in an amount of 0.5 to 1 part by weight as heat-resistant additives with respect to 100 parts by weight of the first resin composition and the second resin composition.

In one embodiment of the present disclosure, the heat-resistant additive may further include a polymer material selected from the group comprising polyurethane-based polymers, polyester-based polymers, polyamide-based polymers, and combinations thereof, and more preferably, a polyurethane-based polymer having a melting point of 120 to 130° C.

In one embodiment of the present disclosure, the content of the polymer material selected from the group comprising polyurethane-based polymers, polyester-based polymers, polyamide-based polymers, and combinations thereof may be included in an amount of 0.5 to 2.5 parts by weight with respect to 100 parts by weight of the first resin composition and the second resin composition.

In one embodiment of the present disclosure, the adhesive composition may further include an antioxidant. The antioxidant is not particularly limited in type and may include, for example, hindered phenol-based, hydroquinone derivative-based, phenol-based antioxidants, etc.

In one embodiment of the present disclosure, the content of the antioxidant may be included in an amount of 1 to 3 parts by weight with respect to 100 parts by weight of the first resin composition and the second resin composition.

The biomass may be derived from corn, sugarcane, rice straw, castor bean, conifers, starch, resin, lignin, soybean oil, sugar beet, potato, rice husks, bamboo, coconut, sunflower, flax, rice bran, Camelina sativa, seakale, barley stalks, wheat stalks, kenaf, or combinations thereof.

In one embodiment of the present disclosure, the bonding temperature of the adhesive composition may be 75 to 95° C. At this time, when the bonding temperature of the adhesive composition is lower than 75° C., the possibility of dismantling through heating may decrease, and thus, the eco-friendliness may decrease. Also, a problem may occur where bonding is impossible because the melting point is higher than the bonding temperature, and when the bonding temperature of the adhesive composition is higher than 95° C., problems such as damage or shrinkage of the surface material may occur.

A second aspect of the present disclosure provides an automotive interior material manufactured using an adhesive composition including: a first resin composition including biomass-derived carboxylic acid monomers and ethylenediamine monomers, a second resin composition including biomass-derived carboxylic acid monomers and hexamethylenediamine monomers, and a heat-resistant additive.

Detailed descriptions of portions overlapping with those of the first aspect of the present disclosure have been omitted, but the contents described for the first aspect of the present disclosure may be equally applied even if the description thereof has been omitted from the second aspect.

Hereinafter, the automotive interior material according to the second aspect of the present disclosure will be described in detail.

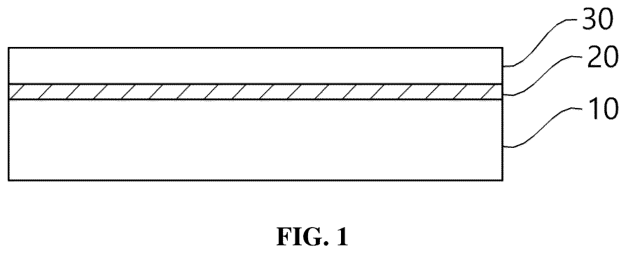

FIG. 1 is a cross-sectional view illustrating an automotive interior material according to the present disclosure. Referring to FIG. 1, the automotive interior material may include a substrate 10, an adhesive layer 20 positioned on one surface of the substrate 10 and including the adhesive composition, and a surface material 30 positioned on the adhesive layer 20.

The substrate 10 may be a base layer forming the overall shape of the automotive interior material.

The substrate 10 may have open cells such as sponge, foam, or non-woven fabric. However, the type of the substrate 10 is not limited thereto, and may also be a film, a sheet, etc.

The adhesive layer 20 may be formed by applying the above-described adhesive composition onto the substrate 10.

The surface layer 30 is positioned at the outermost part and is exposed to the outside when the automotive interior material is applied to an automobile.

The type of the surface layer 30 is not particularly limited thereto, and may be, for example, leather, plastic, etc.

A third aspect of the present disclosure provides a manufacturing method of automotive interior materials, the manufacturing method including: preparing an adhesive composition including a first resin composition including biomass-derived carboxylic acid monomers and ethylenediamine monomers, a second resin composition including biomass-derived carboxylic acid monomers and hexamethylenediamine monomers, and a heat-resistant additive; forming an adhesive layer by uniformly applying the adhesive composition onto one surface of a substrate; and laminating and heating a surface material on the adhesive layer.

Detailed descriptions of portions overlapping with those of the first aspect of the present disclosure have been omitted, but the contents described for the first aspect of the present disclosure may be equally applied even if the description thereof has been omitted from the third aspect.

Hereinafter, the automotive interior material according to the third aspect of the present disclosure will be described in detail.

FIG. 1 is a cross-sectional view illustrating an automotive interior material according to the present disclosure. Referring to FIG. 1, the automotive interior material may include a substrate 10, an adhesive layer 20 positioned on one surface of the substrate 10 and including the adhesive composition, and a surface material 30 positioned on the adhesive layer 20.

The substrate 10 may be a base layer forming the overall shape of the automotive interior material.

The substrate 10 may have open cells such as sponge, foam, or non-woven fabric. However, the type of the substrate 10 is not limited thereto, and may also be a film, a sheet, etc.

The adhesive layer 20 may be formed by applying the above-described adhesive composition onto the substrate 10.

The surface layer 30 is positioned at the outermost part and is exposed to the outside when the automotive interior material is applied to an automobile.

The type of the surface layer 30 is not particularly limited thereto, and may be, for example, leather, plastic, etc.

In one embodiment of the present disclosure, the forming of the adhesive layer according to the present disclosure may be forming the adhesive layer by melt-spraying the adhesive composition onto one surface of the substrate.

In one embodiment of the present disclosure, the method of melt-spraying the adhesive composition may be injecting the adhesive composition through holes having a diameter of 0.03 to 0.3 mm. At this time, when the diameter of injection holes for injecting the adhesive composition is less than 0.03 mm, the diameter of the injected adhesive composition is too thin. As a result, the bonding strength between the surface material and the substrate is insufficient, which may cause a problem that the peel strength is reduced, or the adhesive composition is ununiformly applied, which may cause a problem that a deviation occurs in peel strength performance. When the diameter of the injection holes for injecting the adhesive composition is more than 0.3 mm, the diameter of the adhesive composition to be applied is large. Accordingly, there may be a portion where the adhesive overlaps or aggregates, and as a result, there may be a problem of hardening or curing due to the excessive amount of the adhesive.

In one embodiment of the present disclosure, the heating step may be performed at a temperature of 75 to 95° C. At this time, when the heating temperature is lower than 75° C., the possibility of dismantling through heating may decrease, and accordingly, the eco-friendliness may decrease. Also, a situation may occur where bonding is impossible because the melting point is higher than the bonding temperature. Additionally, when the heating temperature is higher than 95° C., problems such as damage or shrinkage of the surface material may occur.

Hereinafter, Examples of the present disclosure will be described in detail to be easily implemented by those skilled in the art. However, the present disclosure may be implemented in various different forms and is not limited to Examples described herein.

### Example 1

### 1-1. Preparation of Adhesive Composition

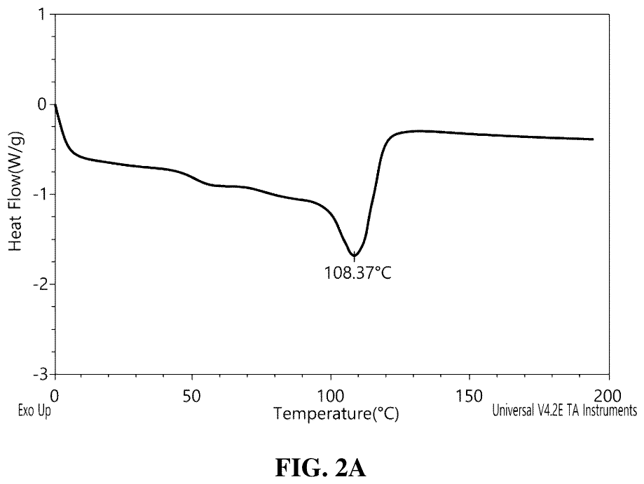

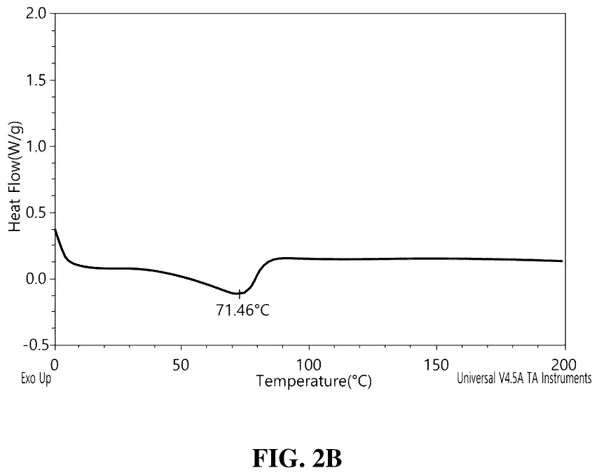

Under inert conditions filled with nitrogen gas, a first resin composition containing stearic acid monomers and ethylenediamine monomers in a weight ratio of 100:33 and a second resin composition containing stearic acid monomers and hexamethylenediamine monomers in a weight ratio of 100:54 were added to a round bottom flask equipped with a mechanical stirrer at a weight mixing ratio of 1:9. Thereafter, 2 parts by weight of a phenolic antioxidant was added to 100 parts by weight of the first resin composition and the second resin composition, and 1 part by weight of a Milbex product including a compound having a structure of Chemical Formula 1 below and 1 part by weight of a TPU having a melting point of 120 to 130° C. were added as heat-resistant additives to 100 parts by weight of the first resin composition and the second resin composition, and then reacted at a temperature of 220° C. for about 5 hours to prepare a biomass-derived adhesive composition for automotive interior materials. Meanwhile, the melting points of the first resin composition and the second resin composition used in the adhesive composition were measured, and the results thereof were shown in FIGS. 2A and 2B. As shown in FIGS. 2A and 2B, the melting points of the first resin composition and the second resin composition were 108.37° C. and 71.48° C., respectively.

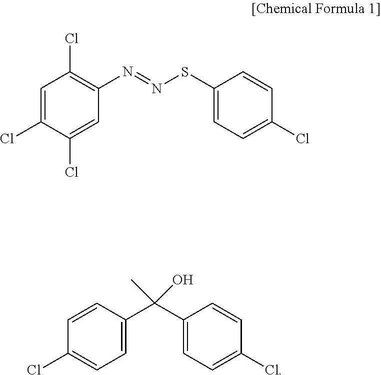 [SMILES: Clc1ccc(S/N=N/c2cc(Cl)c(Cl)cc2Cl)cc1 ; CC(O)(c1ccc(Cl)cc1)c1ccc(Cl)cc1]

### 1-2. Manufacture of Automotive Interior Material Using Adhesive Composition

A sponge made of a polyurethane material was prepared as a cushion fabric, and an adhesive layer was formed on one surface of the cushion fabric by injecting the prepared adhesive composition with a diameter of 0.03 mm to 0.3 mm using a melt-spraying method attached with a recognition sensor. Next, a leather fabric was placed as a surface fabric on the adhesive layer, heated at 75 to 95° C. for 35 seconds, and then cooled to complete an automotive interior material.

### Example 2

From Example 1, except that the content of the heat-resistant additive in the adhesive composition was included as 1 part by weight instead of 2 parts by weight, other compositions, contents, and the preparation method of the automotive interior material were performed in the same manner as in Example 1.

### Example 3

From Example 1, except that the content of the heat-resistant additive in the adhesive composition was included as 3 parts by weight instead of 2 parts by weight, other compositions, contents, and the preparation method of the automotive interior material were performed in the same manner as in Example 1.

Hereinafter, the components and contents of the adhesive compositions according to Examples 1 to 3 were summarized and shown in Table 1 below.

TABLE 1

| | | Second | | Heat-resistant | |
|---|---|---|---|---|---|
| | First resin | resin | Anti- | additive | |
| Classification | composition | composition | oxidant | Milbex | TPU |
| Example 1 | 10 | 90 | 2 | 1 | 1 |
| Example 2 | 10 | 90 | 2 | 0.5 | 0.5 |
| Example 3 | 10 | 90 | 2 | 0.5 | 2.5 |

Unit: parts by weight

### Comparative Example 1

An automotive interior material was manufactured in the same manner as in Example 1, except that the first resin composition was included in an amount of 50 parts by weight instead of 10 parts by weight, the second resin composition was included in an amount of 50 parts by weight instead of 90 parts by weight, and no heat-resistant additive was included.

### Comparative Example 2

An automotive interior material was manufactured in the same manner as in Example 1, except that the first resin composition was included in an amount of 40 parts by weight instead of 10 parts by weight, the second resin composition was included in an amount of 60 parts by weight instead of 90 parts by weight, and no heat-resistant additive was included, in the adhesive composition prepared in Example 1.

### Comparative Example 3

An automotive interior material was manufactured in the same manner as in Example 1, except that the first resin composition was included in an amount of 30 parts by weight instead of 10 parts by weight, the second resin composition was included in an amount of 70 parts by weight instead of 90 parts by weight, and no heat-resistant additive was included, in the adhesive composition prepared in Example 1.

### Comparative Example 4

An automotive interior material was manufactured in the same manner as in Example 1, except that the first resin composition was included in an amount of 20 parts by weight instead of 10 parts by weight, the second resin composition was included in an amount of 80 parts by weight instead of 90 parts by weight, and no heat-resistant additive was included, in the adhesive composition prepared in Example 1.

### Comparative Example 5

An automotive interior material was manufactured in the same manner as in Example 1, except that no heat-resistant additive was included in the adhesive composition prepared in Example 1.

### Comparative Example 6

An automotive interior material was manufactured in the same manner as in Example 1, except that the first resin composition was included in an amount of 50 parts by weight instead of 10 parts by weight, and the second resin composition was included in an amount of 50 parts by weight instead of 90 parts by weight, in the adhesive composition prepared in Example 1.

### Comparative Example 7

An automotive interior material was manufactured in the same manner as in Example 1, except that the first resin composition was included in an amount of 30 parts by weight instead of 10 parts by weight, and the second resin composition was included in an amount of 70 parts by weight instead of 90 parts by weight, in the adhesive composition prepared in Example 1.

### Comparative Example 8

An automotive interior material was manufactured in the same manner as in Example 1, except that the heat-resistant additive was included in an amount of 0.5 part by weight instead of 2 parts by weight in the adhesive composition prepared in Example 1.

### Comparative Example 9

An automotive interior material was manufactured in the same manner as in Example 1, except that the heat-resistant additive was included in an amount of 4 parts by weight instead of 2 parts by weight in the adhesive composition prepared in Example 1.

### Comparative Example 10

An automotive interior material was manufactured in the same manner as in Example 1, except that the heat-resistant additive was included in an amount of 5 parts by weight instead of 2 parts by weight in the adhesive composition prepared in Example 1.

Hereinafter, the components and contents of the adhesive compositions according to Comparative Examples 1 to 10 were summarized and shown in Table 2 below.

TABLE 2

| | | Second | | Heat-resistant | |
|---|---|---|---|---|---|
| | First resin | resin | Anti- | additive | |
| Classification | composition | composition | oxidant | Milbex | TPU |
| Comparative | 50 | 50 | 2 | — | — |
| Example 1 | | | | | |
| Comparative | 40 | 60 | 2 | — | — |
| Example 2 | | | | | |
| Comparative | 30 | 70 | 2 | — | — |
| Example 3 | | | | | |
| Comparative | 20 | 80 | 2 | — | — |
| Example 4 | | | | | |
| Comparative | 10 | 90 | 2 | — | — |
| Example 5 | | | | | |
| Comparative | 50 | 50 | 2 | 1 | 1 |
| Example 6 | | | | | |
| Comparative | 30 | 70 | 2 | 1 | 1 |
| Example 7 | | | | | |
| Comparative | 10 | 90 | 2 | 0.5 | — |
| Example 8 | | | | | |
| Comparative | 10 | 90 | 2 | 1 | 3 |
| Example 9 | | | | | |
| Comparative | 10 | 90 | 2 | 1 | 4 |
| Example 10 | | | | | |

Unit: parts by weight

### Experimental Example

With respect to the automotive interior materials manufactured using the adhesive compositions of Examples 1 to 3 and Comparative Examples 1 to 10 above, according to a standard test method of MS715-73 (for adhesive-interior parts), the bonding strength, heat cycle resistance, creep durability, bending wrinkles, and leather shrinkage rate were evaluated, and the results thereof and desired pass criteria were shown in Tables 3 and 4 below.

TABLE 3

| | | | Bonding | Heat cycle | Creep | | |
|---|---|---|---|---|---|---|---|
| | Melting | Bonding | strength | resistance | durability | | Leather |
| | point | temperature | (N/25 | (N/25 | 80° C. | Bending | shrinkage |
| Classification | (° C.) | (° C.) | mm) | mm) | (mm) | wrinkles | rate |
| Ex. 1 | 89 | 75-95° C. | Pass | Pass | Pass (0 | Pass | Pass 0% |
| | | | (9N) | (8N) | mm, 0 | | |
| | | | | | mm) | | |
| Ex. 2 | 87 | | Pass | Pass | Pass (6 | Pass | Pass 0% |
| | | | (8N) | (6N) | mm, 4 | | |
| | | | | | mm) | | |
| Ex. 3 | 92 | | Pass | Pass | Pass (0 | Pass | Pass 0% |
| | | | (7N) | (7N) | mm, 0 | | |
| | | | | | mm) | | |
| Com. Ex. | 103 | 95-115° C. | Pass | Pass | Pass (0 | Pass | Failure 3% |
| 1 | | | (10N) | (8N) | mm, 0 | | |
| | | | | | mm) | | |
| Com. Ex. | 100 | | Pass | Pass | Pass (0 | Pass | Failure 3% |
| 2 | | | (10N) | (7N) | mm, 0 | | |
| | | | | | mm) | | |
| Com. Ex. | 96 | | Pass | Pass | Failure (15 | Pass | Pass 1% |
| 3 | | | (8N) | (5N) | mm, 30 | | |
| | | | | | mm) | | |
| Com. Ex. | 90 | 75-95° C. | Pass | Failure | Failure (35 | Pass | Pass 0% |
| 4 | | | (8N) | (4N) | mm, 33 | | |
| | | | | | mm) | | |
| Com. Ex. | 85 | | Pass | Failure | Failure (33 | Pass | Pass 0% |
| 5 | | | (9N) | (4N) | mm, 30 | | |
| | | | | | mm) | | |
| Com. Ex. | 105 | | — | — | — | — | — |
| 6 | | | | | | | |
| Com. Ex. | 98 | | Failure | Failure | Failure (30 | Pass | Pass 0% |
| 7 | | | (4N) | (4N) | mm, 35 | | |
| | | | | | mm) | | |
| Com. Ex. | 86 | | Pass | Failure | Failure (13 | Pass | Pass 0% |
| 8 | | | (9N) | (4N) | mm, 15 | | |
| | | | | | mm) | | |
| Com. Ex. | 95 | | Pass | Pass | Pass (0 | Failure | Pass 0% |
| 9 | | | (5N) | (5N) | mm, 0 | | |
| | | | | | mm) | | |
| Com. Ex. | 97 | | Failure | Failure | Failure | Failure | Pass 0% |
| 10 | | | (3N) | (2N) | (2N) | | |

TABLE 4

| | Bonding | Heat cycle | Creep | | Leather |
|---|---|---|---|---|---|
| | strength | resistance | durability | Bending | shrinkage |
| | (N/25 mm) | (N/25 mm) | 80° C. (mm) | wrinkles | rate |
| Pass | 5 or higher or | 5 or higher or | 10 or less | Visual | Less than 3 |
| criteria | destruction of | destruction of | | evaluation | |
| | substrate | substrate | | | |

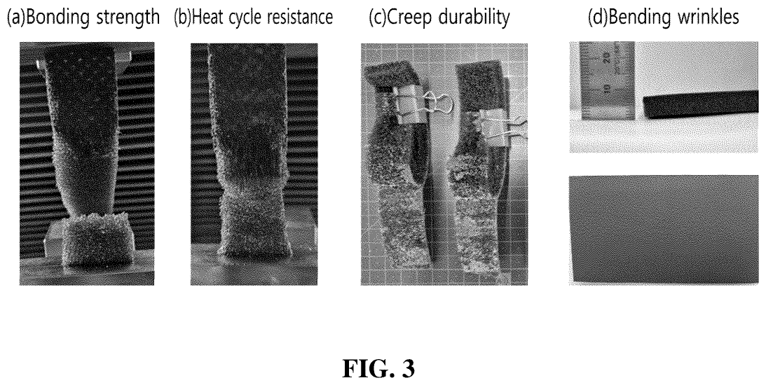

FIG. 3 is a photograph showing results of evaluating physical properties of the automotive interior material manufactured according to Example 1. Referring to FIG. 3 and Table 3 above, the automotive interior material manufactured according to Example 1 exhibited excellent physical properties in all evaluation items, including bonding strength, heat cycle resistance, creep durability, bending wrinkles, and leather shrinkage rate. It was confirmed that not only the bonding strength and heat cycle resistance values were significantly excellent, but also no peeling occurred at all in the evaluation of creep durability, no deformation of the leather occurred in the evaluation of leather shrinkage rate, and the resilience to bending was very excellent. In addition, as results of evaluating the physical properties of the automotive interior materials manufactured according to Examples 2 and 3, it was confirmed that not only the bonding strength and heat cycle resistance were very excellent in the same manner as Example 1, but also no changes were observed in the evaluation of bending wrinkles and leather shrinkage rate.

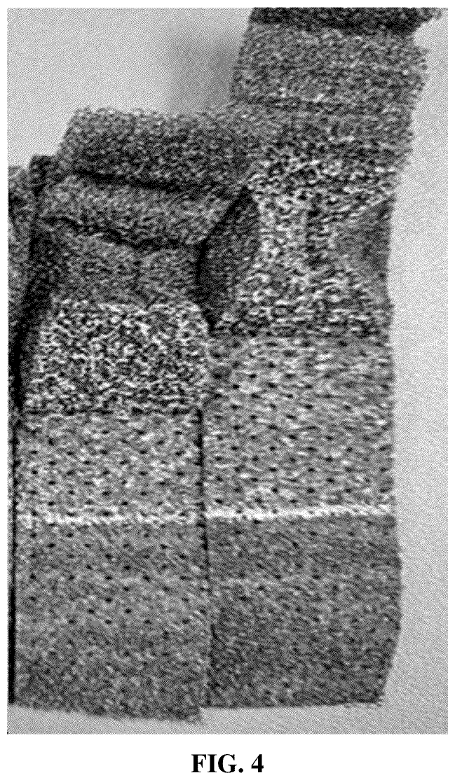

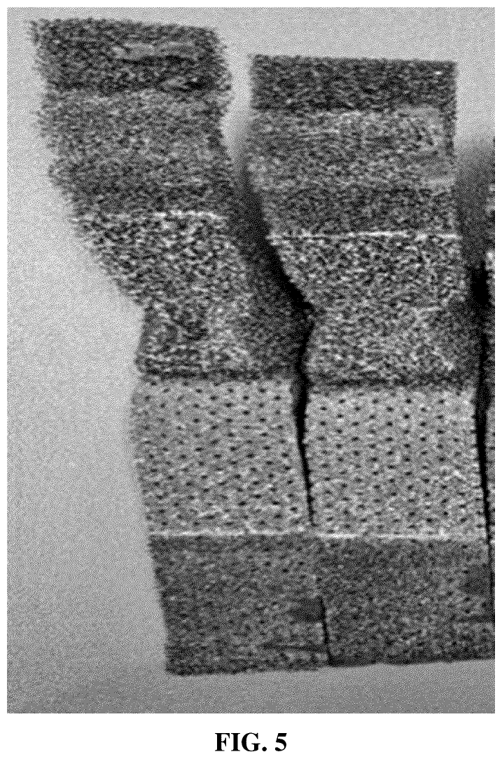

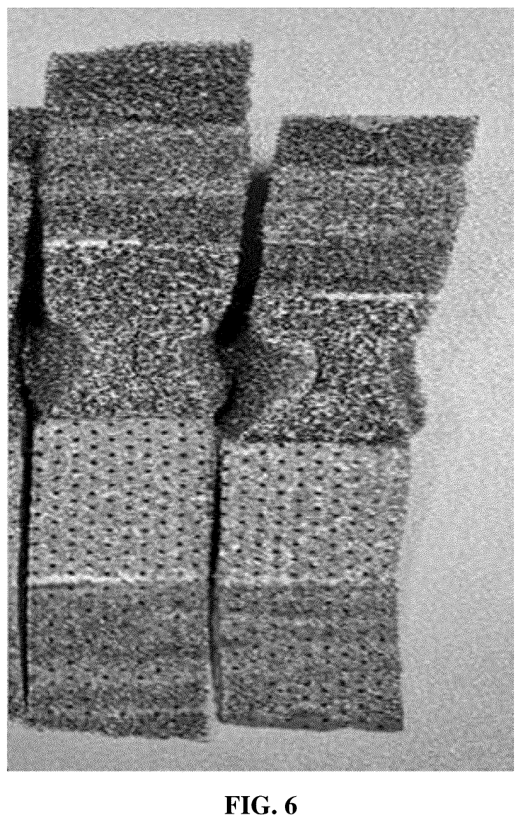

On the other hand, in Comparative Examples 1 to 5, no heat-resistant additive was included, and thus it was evaluated that the heat cycle resistance, creep durability, and leather shrinkage rate were poor. Specifically, in Comparative Examples 1 and 2, the leather shrinkage rate was 3% each, which did not reach the pass criteria of less than 3%. FIGS. 4 to 6 are photographs observing states after creep durability evaluation of Comparative Examples 3 to 5, respectively. Referring to FIGS. 4 to 6 and Table 3, as a result of the creep durability evaluation, Comparative Example 3 was evaluated as 15 mm and 30 mm, Comparative Example 4 was evaluated as 35 mm and 33 mm, and Comparative Example 5 was peeled off at 33 mm and 30 mm. That is, it was confirmed that automotive interior materials were sagging and the durability was reduced. In addition, the heat cycle resistance of Comparative Examples 4 and 5 both was 4N, which did not reach a target level.

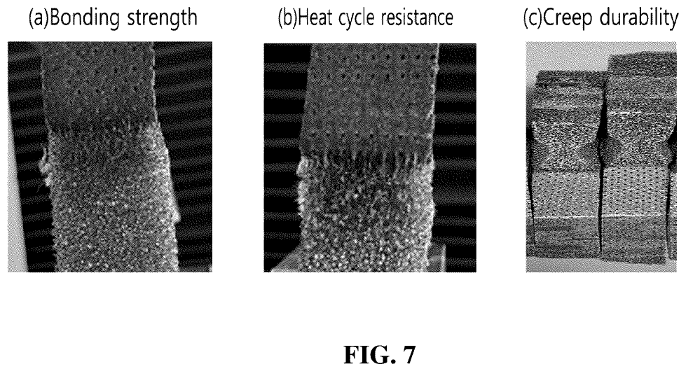

In addition, compared to Example 1, Comparative Example 6, containing 50 parts by weight of the first resin composition and 50 parts by weight of the second resin composition, had a melting point higher than the bonding temperature, thereby making it impossible to be bonded during the manufacturing process of automotive interior materials, and thus making it impossible to evaluate the physical properties. FIG. 7 is a photograph showing states after evaluation of bonding strength, heat cycle resistance, and creep durability of Comparative Example 7 containing 30 parts by weight of the first resin composition and 70 parts by weight of the second resin composition, compared to Example 1, respectively. Referring to FIG. 7 and Table 3, it was confirmed that Comparative Example 7 had poor bonding strength and heat cycle resistance of 4N each, and 30 mm and 35 mm were peeled off even in the creep durability evaluation. Accordingly, an effect of the weight mixing ratio of the first resin composition and the second resin composition on the automotive interior was confirmed, and it was confirmed that when the weight mixing ratio of the first resin composition and the second resin composition according to the present disclosure was 1:3 to 1:12, all of the physical properties of bonding strength, heat cycle resistance, creep durability, bending wrinkles, and leather shrinkage rate were excellent.

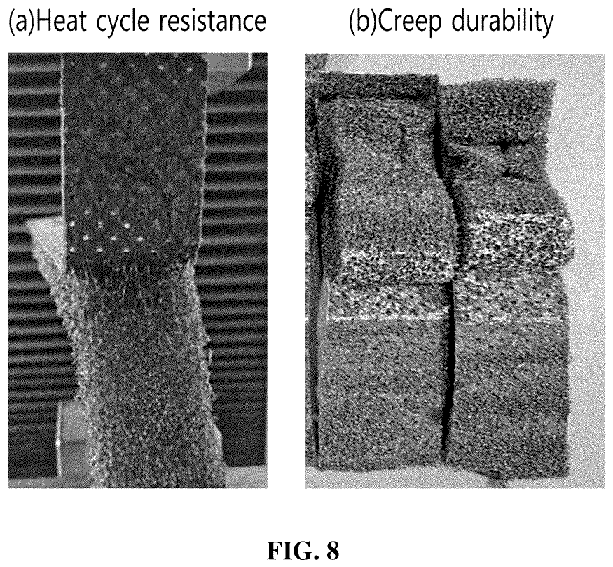

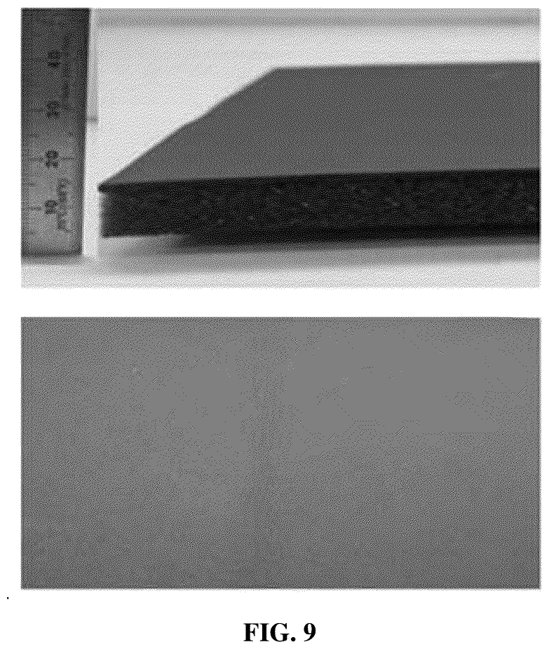

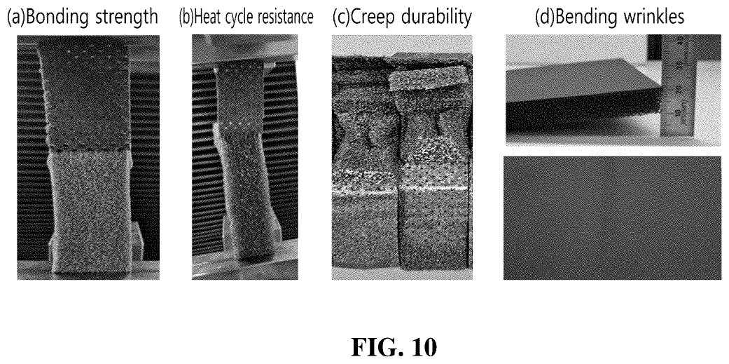

Next, FIG. 8 is a photograph observing states after evaluating the heat cycle resistance and creep durability of Comparative Example 8 containing less than 1 part by weight of a heat-resistant additive, compared to Example 1. Referring to FIG. 8 and Table 3, it was confirmed that Comparative Example 8 had poor heat cycle resistance, and 13 mm and 15 mm were peeled off even in the creep durability evaluation. FIG. 9 is a photograph of a side (upper part) and a surface (lower part) of an automotive interior material of Comparative Example 9 after evaluation of bending wrinkles of Comparative Example 9 containing more than 3 parts by weight of a heat-resistant additive, compared to Example 1. Referring to FIG. 9, it was confirmed that in Comparative Example 9, the content of the heat-resistant additive was included in a range of more than 3 parts by weight with respect to 100 parts by weight of the first resin composition and the second resin composition, and thus the automotive interior material had poor resilience to bending. FIG. 10 is a photograph observing states after evaluating the bonding strength, heat cycle resistance, creep durability, and bending wrinkles of Comparative Example 10 containing 5 parts by weight of a heat-resistant additive, respectively, compared to Example 1. Referring to FIG. 10, it was confirmed that in Comparative Example 10, the content of the heat-resistant additive was included in a range of more than 3 parts by weight with respect to 100 parts by weight of the first resin composition and the second resin composition, and thus most of physical properties were poor.

That is, it was confirmed that the physical properties of the adhesive composition were all excellent when the first resin composition and the second resin composition according to the present disclosure were included in the mixing ratio and the heat-resistant additive was included in the numerical content.

What is claimed is:

1. An adhesive composition for automotive interior materials, the adhesive composition comprising:
a first resin composition comprising first carboxylic acid monomers and ethylenediamine monomers;
a second resin composition comprising second carboxylic acid monomers and hexamethylenediamine monomers; and
a heat-resistant additive.

2. The adhesive composition of claim 1, wherein a weight mixing ratio of the first resin composition and the second resin composition is 1:3 to 1:12.

3. The adhesive composition of claim 1, wherein a weight ratio of the first carboxylic acid monomers and the ethylenediamine monomers included in the first resin composition is 100:17 to 100:54.

4. The adhesive composition of claim 1, wherein a weight ratio of the second carboxylic acid monomers and the hexamethylenediamine monomers included in the second resin composition is 100:33 to 100:82.

5. The adhesive composition of claim 1, wherein a melting point of the first resin composition is 108 to 112° C., and a melting point of the second resin composition is 70 to 80° C.

6. The adhesive composition of claim 1, wherein the first carboxylic acid monomers or the second carboxylic acid monomers are selected from the group consisting of stearic acid, sebacic acid, undecanedioic acid, dodecanedioic acid, tridecanedioic acid, tetradecanedioic acid, and a combination thereof.

7. The adhesive composition of claim 1, wherein the heat-resistant additive is included in an amount of 1 to 3 parts by weight with respect to 100 parts by weight of the first resin composition and the second resin composition.

8. The adhesive composition of claim 1, wherein the heat-resistant additive comprises a material selected from the group consisting of a compound having a structure represented by a following Chemical Formula 1, calcium carbonate, bentonite, sorbitol, phosphate salts, calcium carboxylate, and a combination thereof

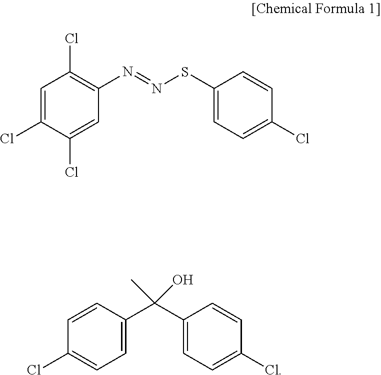 [SMILES: Clc1ccc(S/N=N/c2cc(Cl)c(Cl)cc2Cl)cc1 ; CC(O)(c1ccc(Cl)cc1)c1ccc(Cl)cc1]

9. The adhesive composition of claim 8, wherein the material is included in an amount of 0.5 to 1 part by weight with respect to 100 parts by weight of the first resin composition and the second resin composition.

10. The adhesive composition of claim 1, wherein the heat-resistant additive comprises a polymer material selected from the group consisting of polyurethane-based polymers, polyester-based polymers, polyamide-based polymers, and a combination thereof.

11. The adhesive composition of claim 10, wherein the polymer material is included in an amount of 0.5 to 2.5 parts by weight with respect to 100 parts by weight of the first resin composition and the second resin composition.

12. The adhesive composition of claim 1, further comprising an antioxidant.

13. The adhesive composition of claim 12, wherein the antioxidant is included in an amount of 1 to 3 parts by weight with respect to 100 parts by weight of the first resin composition and the second resin composition.

14. The adhesive composition of claim 1,
wherein the first carboxylic acid monomers, the ethylenediamine monomers, the second carboxylic acid monomers, or the hexamethylenediamine monomers are biomass-derived,
wherein the biomass includes corn, sugarcane, rice straw, castor bean, conifers, starch, resin, lignin, soybean oil, sugar beet, potato, rice husks, bamboo, coconut, sunflower, flax, rice bran, Camelina sativa, seakale, barley stalks, wheat stalks, kenaf, or a combination thereof.

15. The adhesive composition of claim 1, wherein a bonding temperature of the adhesive composition is 75 to 95° C.

16. An automotive interior material manufactured using the adhesive composition of claim 1.

17. A method of manufacturing automotive interior materials, the method comprising:
preparing an adhesive composition including:
a first resin composition including first biomass-derived carboxylic acid monomers and biomass-derived ethylenediamine monomers;
a second resin composition including second biomass-derived carboxylic acid monomers and biomass-derived hexamethylenediamine monomers; and
a heat-resistant additive;
forming an adhesive layer by uniformly applying the adhesive composition onto one surface of a substrate; and
laminating and heating a surface material on the adhesive layer.

18. The method of claim 17, wherein the forming of the adhesive layer is forming the adhesive layer by melt-spraying the adhesive composition onto the one surface of the substrate.

19. The method of claim 18, wherein the melt-spraying of the adhesive composition is injecting the adhesive composition through a hole having a diameter of 0.03 to 0.3 mm.

20. The method of claim 17, wherein the heating of the surface material is performed at a temperature of 75 to 95° C.
